(19) United States
(12) Patent Application Publication
(10) Pub. No.: US 2025/0241482 A1
(43) Pub. Date: Jul. 31, 2025

(54) VARIABLE AIR FLOW AIR FRYER

(71) Applicant: Midea Group Co., Ltd., Foshan (CN)

(72) Inventors: Clayton O'Donoghue, Louisville, KY (US); Matthew Hunter, Louisville, KY (US)

(73) Assignee: Midea Group Co., Ltd., Foshan (CN)

(21) Appl. No.: 18/423,108

(22) Filed: Jan. 25, 2024

(51) Int. Cl. A47J 36/32; A47J 27/00

(52) U.S. Cl. CPC A47J 36/321; A47J 27/002; A47J 27/004

(57) ABSTRACT

A cooking appliance with a variable airflow for cooking an artifact using convection current to transfer heat to the artifact. The cooking appliance has a user application with an interface that receives user parameters and a function for cooking. A control system sets up the cooking appliance and activates a fan according to the user parameters. A variable airflow is created by controlling the velocity of the fan using different geometries of the blade of the fan depending upon the function. A temperature sensor(s) provides temperature measurement of the artifact to a control system that regulates the variable airflow according to the user parameters. The cooking appliance also includes a variac that is mounted on a motor that controls the velocity of the fan(s).

### BACKGROUND

This disclosure relates in general to convection heat transfer in air fryer systems and, not by way of limitation, to provisioning airflow in the air fryer for cooking, among other things.

The modern consumer landscape increasingly demands cooking appliances that offer a balance between convenience, speed, and health consciousness. Traditional cooking methods often involve excessive amounts of oil, leading to concerns about the nutritional content of prepared meals.

Air fryers have gained popularity as a healthier alternative to deep frying, utilizing hot air to cook food with a fraction of the oil traditionally entailed. The core technology behind air fryers involves a powerful heating element and a high-speed fan, creating a convection effect to rapidly circulate hot air around the food. However, existing air fryer designs have limitations in achieving optimal air distribution and heat transfer, which can impact the overall cooking process.

Conventional air fryers often struggle with uniform heat distribution, leading to unevenly cooked food. Certain areas may receive more heat than others, resulting in overcooked or undercooked portions. Additionally, the limitations in air circulation may hinder the crispiness and texture that consumers associate with fried foods. Addressing these challenges ensures consistent, high-quality results across various food items.

### SUMMARY

In one embodiment, the present disclosure provides a cooking appliance with a variable airflow for cooking an artifact using convection current to transfer heat to the artifact. The cooking appliance has an interface to a user application that receives user parameters and a function for cooking. A control system sets up the cooking appliance and activates a fan according to the user parameters. The variable airflow is created by controlling the velocity of the fan using different geometries of the blade of the fan depending upon the function. A temperature sensor provides temperature measurement of the artifact to the control system that regulates the variable airflow according to the user parameters. The cooking appliance also includes a variac (i.e., variable autotransformer) that is mounted on a motor that controls the velocity of the fan(s).

In another embodiment, a cooking appliance with a variable airflow for cooking an artifact using convention current. The cooking appliance comprises a fan, wherein the fan creates the variable airflow. The cooking appliance comprises a communication module and a motor with variable speed control. The cooking appliance comprises an interface coupled with the communication module that receives a function of cooking and a plurality of user parameters for cooking the artifact. The interface receives a function of cooking and a plurality of user parameters for cooking an artifact. The cooking appliance comprises an infrared (IR) sensor to provide temperature measurement of the artifact without making contact between the temperature sensor and the artifact to the control system to a control system that regulates the variable airflow according to the plurality of user parameters and the temperature measurement.

In another embodiment, a method for controlling a cooking appliance with a variable airflow for cooking an artifact using convention current. The method comprises of receiving a plurality of user parameters and a function from the user through an interface to the user application. In other step, controlling the airflow depending upon the function by a plurality of blades with variable geometries. The cooking appliance is configured to sense the temperature of the surface of the artifact through a temperature sensor and regulate the plurality of user parameters of airflow to achieve the function.

In yet another embodiment, a cooking appliance with a variable airflow for cooking an artifact using convention current. The cooking appliance comprises a fan, where the fan creates the variable airflow. The cooking appliance comprises a communication module and a variac integrated with a motor to control and monitor velocity of a fan. The velocity of airflow is dependent on the function. The cooking appliance comprises an interface coupled with the communication module that receives a function of cooking and a plurality of user parameters for cooking the artifact. The interface receives a function of cooking and a plurality of user parameter for cooking the artifact. The cooking appliance comprises a temperature sensor to provide temperature measurement of the artifact without making contact between the temperature sensor and the artifact to the control system to a control system that regulates the variable airflow according to the plurality of user parameters and the temperature measurement.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates a block diagram of an embodiment of a system of a cooking appliance with a variable airflow for cooking an artifact using convection current;

FIG. 2 illustrates a block diagram of an embodiment of a control system communicating with a user application;

FIG. 3 illustrates a diagram of an embodiment of a shaded two-pole motor with two fans that can have different blade geometries and are optionally user-swappable;

FIG. 4 illustrates a diagram of an embodiment of a housing base of a heating element with heat resistant structure;

FIG. 5 illustrates a diagram of an embodiment of a pattern of airflow created by the fan;

FIG. 6 illustrates a diagram of an embodiment of a panel of the user application with a number of functions of cooking;

FIG. 7 illustrates a diagram of an embodiment of a panel of the user application to input a customizable cycle;

FIG. 8 illustrates a flow chart of an embodiment of a system of the cooking appliance with the variable airflow for cooking an artifact using convection current; and

FIG. 9 illustrates a flow chart of an embodiment of a control system regulating the user parameters for cooking the artifact.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

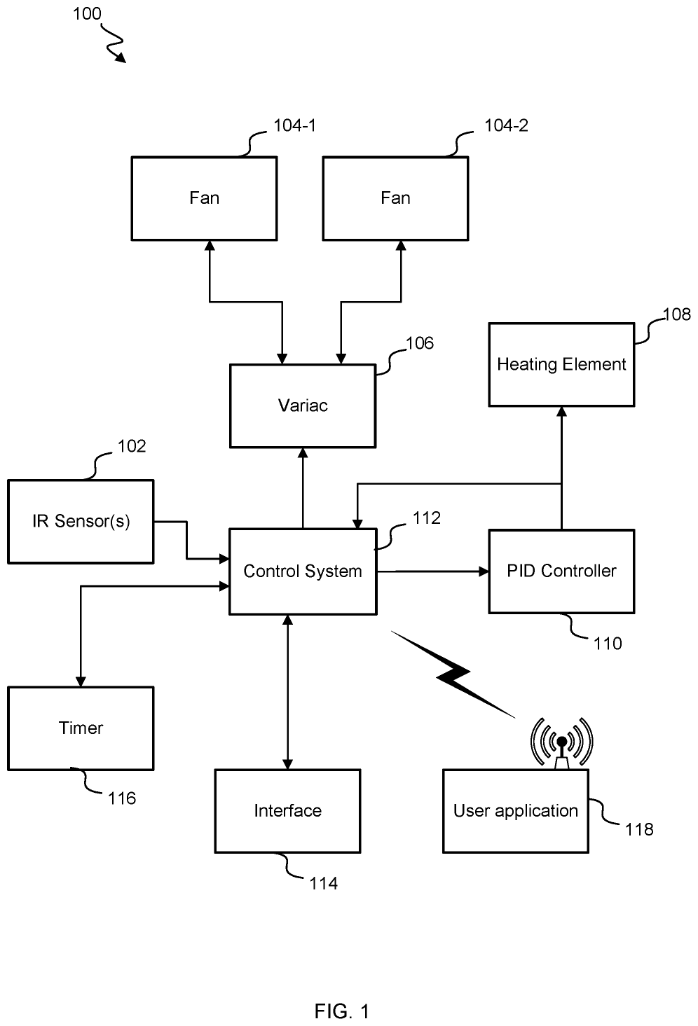

Referring initially to FIG. 1, a system 100 of a cooking appliance with a variable airflow for cooking an artifact (i.e., food item being cooked) using convection air current is shown. The system 100 includes one or more infrared (IR) sensor(s) 102, one or more fan(s) 104, a variac 106, a heating element 108, a proportional-integral-differential (PID) controller 110, a control system 112, an interface 114, a timer 116, and a user application 118. The IR sensor(s) 102 is for touchless measuring temperature of the artifact that is placed in the cooking appliance. The IR sensor(s) 102 has an optic system for receiving infrared rays radiated from the artifact to the IR sensor(s) 102. The control system 112 adapted to convert the output of the IR sensor(s) 102 into a desired electric signal according to the temperature of the artifact. A shield cylinder and/or reflective plates can optionally be used to focus the infrared rays reflected into the IR sensor(s) 102. This embodiment has one IR sensor 102, but other embodiments could use multiple IR sensors 102 to measure temperature of the artifact at several different places and/or different angles. In another embodiment, a thermal imaging camera with non-contact temperature and associated software can be utilized for having a temperature profile of the artifact.

The fan(s) 104 have a motor (not shown) with the variac 106 mounted to the motor. The variac 106 is a variable autotransformer which is a single-coil transformer in which two portions of the same coil are used as a primary and a secondary. The variable autotransformers are used for the same purposes as regular transformers but generally can operate on low voltages.

The heating element 108 is used for heating the air to perform the cooking operation. Air from the fan(s) 104 blow across the heating element 108 to transfer the heat to the artifact being cooked. Flowing air spreads the heat across the artifact more completely and effectively.

The PID controller 110 regulates the performance of the heating element 108. A proportional control determines how much the output of the heating element 108 can change based on a deviation in measured temperature from a desired temperature. The integral control the PID controller 110 helps to eliminate the errors accumulated over time. A derivative control anticipates future errors. The proportional, integral, and derivative constants (Kp, Ki, Kd) are tuned to the working of the system 100. The control system 112 monitors and processes the sensor information. In addition to the IR sensor(s) 102, there could be fan rotation sensor, humidity sensor, air flow sensor, video sensor, VOC sensor, thermal imaging camera etc. in various embodiments for the control system 112 to manage operation of the system 100.

The control system 112 is responsible for communication with the interface 114 and/or the user application 118. The user application 118 and/or interface 114 is used to obtain user input parameters. The user parameters include the temperature, a cooking time, a function, etc. The interface 114 is built-in to the cooking appliance to configure various settings to manipulate the cooking. The user application 118 runs on a user computer or handheld. A networking function in the control system 112 communicates with the user application 118 directly or indirectly through the Internet or a local area network (LAN). Depending upon the various sensor(s) used in the cooking appliances, a user can set user parameters to control the cooking of the artifact.

The timer 116 takes note of the time and enables the cooking appliance to do an operation for a specified amount of time or according to some schedule. There can be one temperature or a series of temperatures according to corresponding time durations for the cook. Feedback from the IR sensor(s) 102 can affect the duration of the cook, energy to the heating element 108, speed of the fan(s) 104.

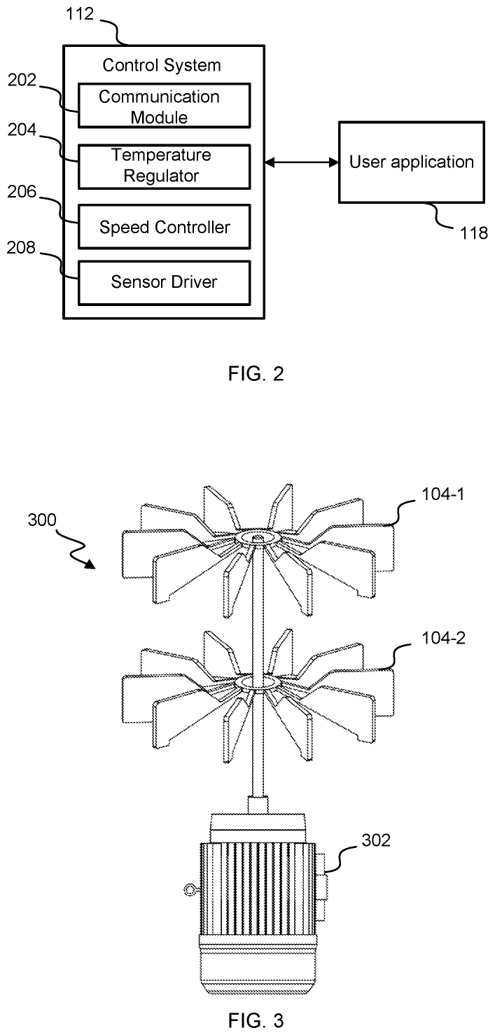

Referring to FIG. 2, a block diagram of an embodiment of the control system 112 communicating with the user application 118 is shown. The control system 112 contains a communication module 202, a temperature regulator 204, a speed controller 206, and a sensor driver 208. The communication module 202 processes the input coming from the interface 114 and/or the user application 118. The control system 112 is part of an internet of things (IoT) ecosystem where the cooking appliance is connected to a WiFi, Zigbee™, Bluetooth™, cellular, or some other wireless protocol. The user can check the status of the cooking from their user application 118 and receive notifications on the user application 118 about a cooking process. The user can preheat the cooking appliance while being away from the home to save time and start cooking as soon as the user gets home. The communication module 202 ensures end-to-end encryption and proper authentication with the user device to restrict access from an unauthorized third party. Communication between the control system 112 and the user application 118 can be indirect through a remote system managing the cooking appliance with input from the user application 118.

The temperature regulator 204 continuously monitors the temperature of the heating element 108 through a temperature sensor such as the IR sensor(s) 102 or probe temperature for insertion to the artifact. The user sets a desired temperature and the PID controller 110 gives the error between an actual temperature and the temperature measurement. The output of the PID controller 110 is used by the temperature regulator 204 to adjust the temperature of the heating element 108 in real time.

The speed controller 206 is responsible for regulating the rotational speed and the direction of the fan motor. The speed controller 206 according to the user input and the cook function that user selected, activates the motor with a calculated voltage. In one embodiment, where a high-temp brushless direct current motor (BLDC) is used to rotate the fan(s) 104, the speed controller 206 uses the pulse width modulation (PWM) to control the speed of the BLDC. The PWM method consists of varying the duty cycle at a fixed frequency to adjust the voltage or current. The sensor driver 208 manages the sensors like the IR sensor(s) 102 and takes input, processes it and the control system 112 generates a response accordingly. The cooking appliance can be equipped with more sensors for measuring the weight of the artifact and a humidity sensor for managing the humidity. The optical imaging sensor for identifying the composition of the artifact combined with the function selected. The control system 112 sets up the cooking appliance according to the input of these sensors to ensure better results. These sensors are managed by the sensor driver 208.

Referring to FIG. 3, a diagram of an embodiment of a shaded two pole motor with two fans 104 that can have different blade geometries and are optionally user-swappable is shown. This embodiment has two fans 104-1, 104-2 connected with one axle to a motor 302. The motor 302 is an electric device that converts electrical power into mechanical energy, specifically in the form of torque delivered through a shaft to the two fans 104. The motor 302 operate on the principle of electromagnetic induction. In one embodiment, the motor 302 is a two-pole shaded motor. The two-pole shaded motor contains two poles (or a single pair of magnetic poles north and south) are said to be a two-pole shaded motor. The number of stator windings can give any reasonable number of poles ranging from two to twelve.

The two-pole shaded motor is controlled by the variac 106 which is a variable autotransformer. In the variac 106, a ratio of the primary to a secondary windings is configurable, which means that the ratio of the secondary voltage to the primary voltage is adjustable. The speed and direction of rotation of motor 302 are regulated by changing the voltage.

The fans 104 with different blade geometry can be manually inserted or can be connected to different motors and placed at different locations from each other depending upon the end design. The fan 104-1 and the fan 104-2 have the same design of blades, but can be different in other embodiments. These distinct geometries create distinct airflow patterns that transfer the heat to the artifact being cooked differently. These geometries are designed to have a specific heat transmission with respect to the functions. For example, one fan 104-1 can be specialized to fry the artifact while fan 104-2 can be designed for baking. The axle could engage one or both of the fans 104 with the motor 302 to achieve different cooking results in combination with control of the motor speed. The fans 104 could be user interchangeable in some embodiments to allow swapping out the fans 104 in the field by the consumer.

In another embodiment, the motor 302 can be theBLDC. The BLDC motors can be controlled, using feedback mechanisms, to precisely deliver the desired torque and rotation speed. Precision control, in turn, reduces energy consumption and heat generation. The BLDC is controlled by an electronic speed controller (ESC). The ESC uses a speed reference signal to change the speed of a switching network of field-effect transistors (FETs). The speed of the motor 302 can be changed by changing a switching frequency or the duty cycle of the FETs by the speed controller 206.

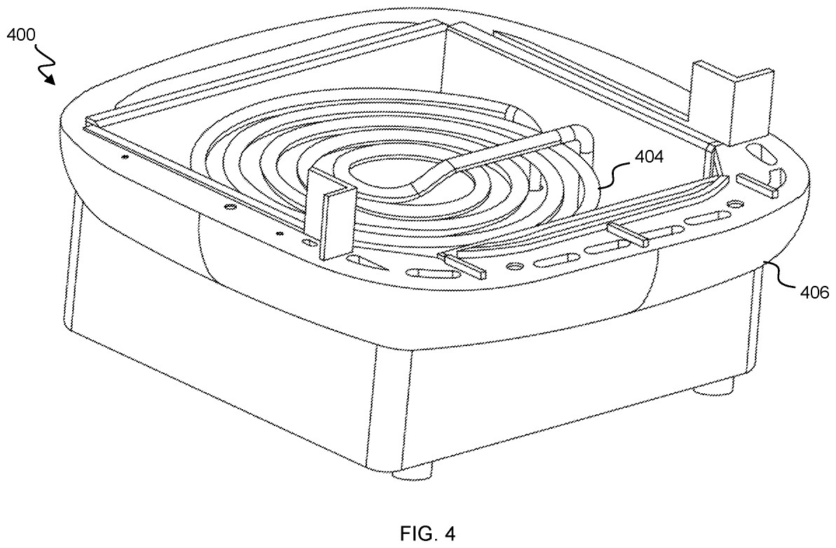

Referring to FIG. 4, a diagram of an embodiment of a housing base 406 of the heating element 108 with a heat resistant structure that is part of an air fryer 400 is shown. A cooking chamber sits on top of the housing base 406 and the heating coil 404 provides heat to the cooking chamber and surrounding air to complete the air fryer 400. The housing base made of heat-resistant material that can withstand temperatures greater than a maximum cooking temperature, for example, 450° F. in this embodiment.

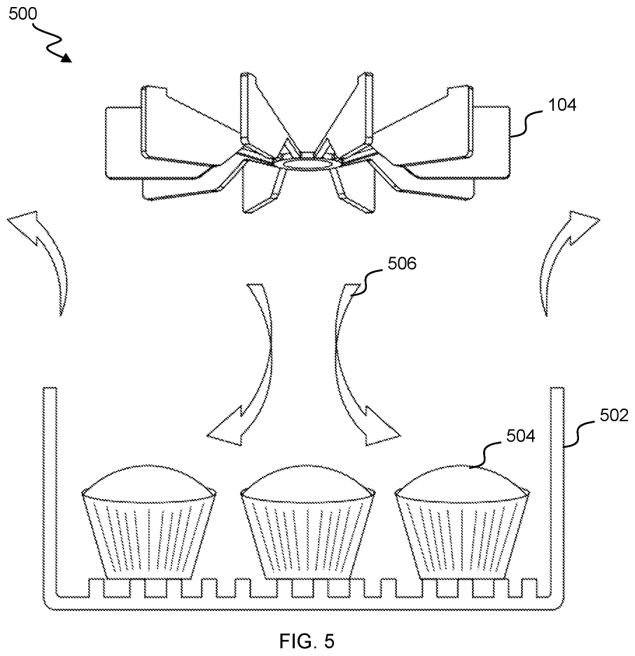

Referring to FIG. 5, a diagram of an embodiment for a pattern of airflow created by the fan 104 in the air fryer cooking appliance is shown. Airflow plays a significant role in achieving the desired results and evenly cooking the artifact 504. The cooking appliance is equipped with a powerful fan system to circulate a controlled airflow. The fan 104 is responsible for circulating hot air currents 506 rapidly around a cooking chamber 500. The heating element 108, located below the cooking chamber as shown in FIG. 4. This heating element 108 heats the air that the fan 104 circulates.

At the bottom or sides of the air fryer, there are vents or orifices that permit fresh air to be drawn into the appliance. The fan 104 draws in the fresh air and directs it over the heating element 108. As the air passes over the heating element 108, it is rapidly heated. The artifact 504 is placed in a perforated basket or on a tray, referred to as cooking basket 502, inside the cooking chamber 500. This design permits the hot air currents 506 to circulate around and through the food. A combination of intense heat and rapid air circulation mimics the cooking process of deep frying but with significantly less or no added oil. The control system 112 is equipped with automatic fan adjustment. A fan speed is same as the speed of the motor 302 and is controlled through the speed controller 206. A fan speed varies during the cooking process to optimize the air circulation based on the food being cooked. The orifices are also open and closed throughout the process to create a suitable airflow and temperature.

This embodiment has a single 104 that may be user swappable or have multiple fans in other embodiments. The fans could have different motors and orientation to control airflow. Where there are multiple fans with different motors, they can be independently controlled to subject the artifact to different air currents. Some embodiments can additionally adjust the fresh air ventilation to circulate more air or add outside air during the cooking process through mechanically covering the fresh air vents. Where there are multiple IR sensors, adjustment of the various motors/fans and air vents can more evenly cook the artifact or as desired. For example, a pie may have a crispy crust by directing airflow to the top, but the bottom receiving less heat from the air currents as the filling only needs warming without additional cooking.

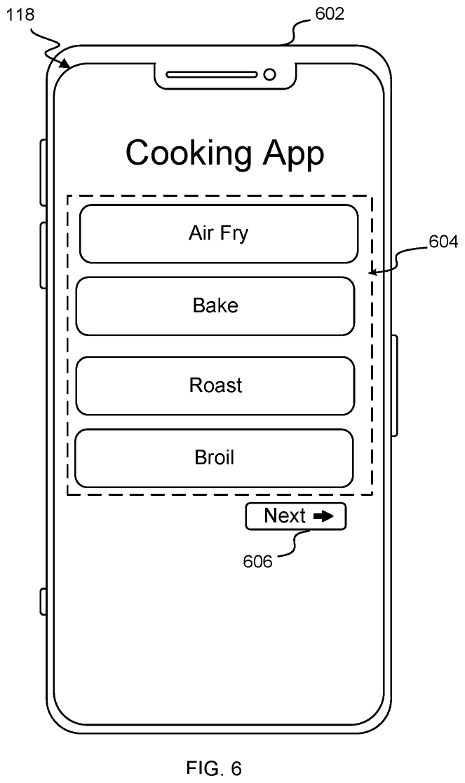

Referring to FIG. 6, a diagram of an embodiment of an interface screen of the user application 118 with the number of functions 604 for cooking is shown. A user device 602 is wirelessly connected to a network i.e., WiFi, Bluetooth™, cellular and/or or any other wireless medium to communicates with the communication module 202 inside the cooking appliance. The same interface screen can be accessed from the interface 114 physically built-in to the cooking appliance. This interface screen in particular displays a menu for selecting a function 604 of cooking. The functions 604 include but are not limited to Air Fry, Bake, Roast, and Broil. The cooking device may offer more features in other embodiments. The next button 606 takes the user to a new menu of customizing your cooking cycle or automating the process.

In another embodiment of the interface screen, the user application takes estimate weight of the artifact or the type of composition of artifact 504 to cook it in a customized way appropriate for the weight and composition. There can be programmed settings for some types of foods like optimized temperature and time as cooking pork is different that cooking lamb. The weight measurement can be used to calculate the internal temperature of the artifact 504 by using a surface temperature measured from the IR sensor(s) 102. The user can also specify how well done the article should be cooked.

The user application 118 can also have recipes preprogrammed or available for download from the cloud. These recipes have optimized user parameters to achieve the desired results for the artifact being cooked. There can be another interface screen to input the water or fat content of the artifact currently present and how much of that water or fat content would the user like to preserve till the end of the cooking process. The user application 118 can additionally provide an option for entering whether the food is frozen or not. In response to the input the user parameters can be set accordingly.

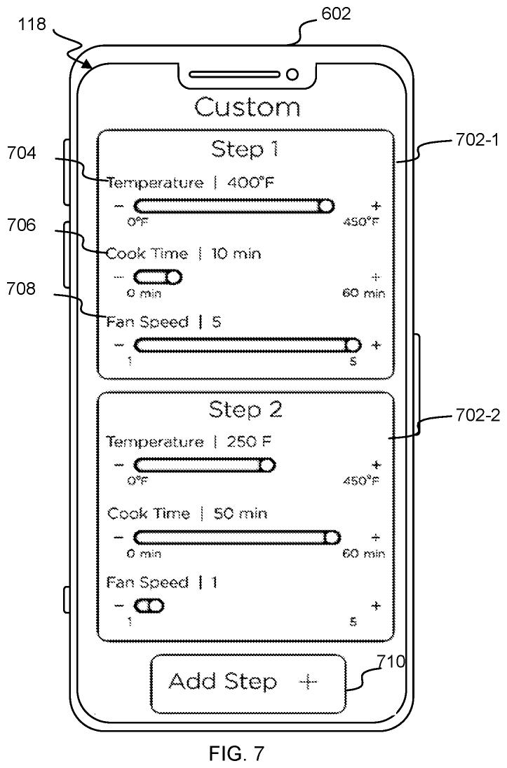

Referring to FIG. 7, a diagram of an embodiment of an interface screen of the user application 118 to input a customizable cycle is shown. The menu shows a customization of the cooking cycle. The cooking cycle can be split into various steps 702 that collectively form a scene. Each step 702 has its own designated user parameters for customization for the user. The control system 112 executes the cooking operation with the setting up of a period defined in cook time 706 for each step 702. The user can add new steps 702 using the add step 710 option. The cooking appliance executes different user parameters for different periods, accordingly for each step over time. The temperature 704 is set between 0°-450° F. range for this cooling appliance. A fan speed 708 controls the amount of heat transferred to the artifact 504 by the convection airflow. In another embodiment, the fan speed 708 can be substituted with other terminology like crispness level which alludes to same meaning. For example, increasing crispiness level corresponds increasing the fan speed 708. There can be other user parameters like humidity, artifact color, internal temperature to ensure moistness or other cooking parameters.

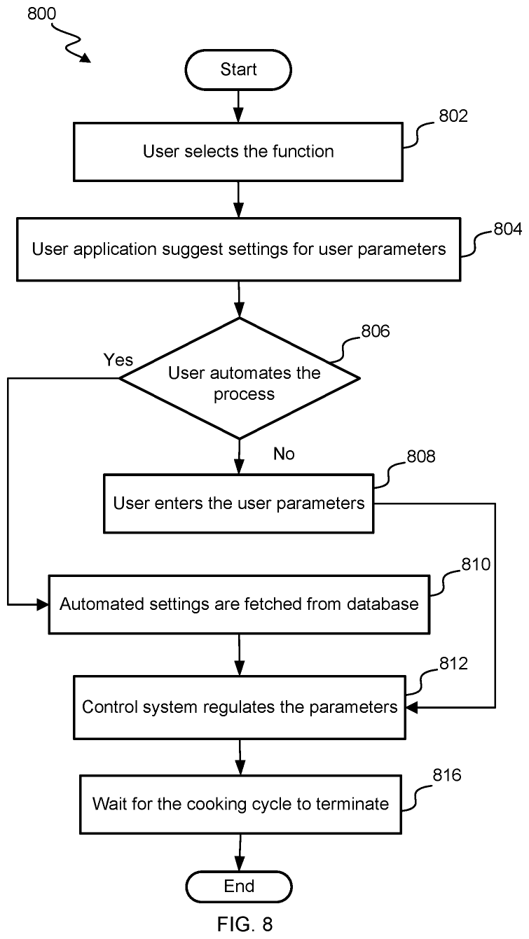

Referring to FIG. 8, a flow chart of an embodiment of the system 100 of a cooking appliance with a variable airflow is shown, that cooks an artifact 504 using convection current. At block 802, a user selects the function 604 out of many options provided by the cooking appliance. The user can operate interface 114 or the user application 118 to program the cooking appliance.

At block 804, the cooking appliance has some scenes programmed within in multiple steps. These scenes have predetermined user parameters for the selected function. Scenes for new recipes can be downloaded or user program too. The scenes are a series of steps taken by the control system 112 in response to particular user prompts. When the user selects the automated option and skips the input of user parameters or uses the automated options as suggestions, at block 806, processing goes to block 810 where the automated settings are fetched from a memory and/or the cloud and implemented by the control system 112. If the user does not automate the process in block 806, the user inputs the user parameters manually at block 808. The exemplary panel of the user parameters is shown in FIG. 7 for one embodiment. The user application 118 can be expanded in other implementations to control other parameters, read other sensor data, and/or add additional steps.

At block 812, the control system 112 regulates the parameters to ensure the system sticks to the selected user parameters so that the artifact 504 is cooked as per the requirement step(s). The process continues through the scenes until the cooking cycle is terminated in block 816.

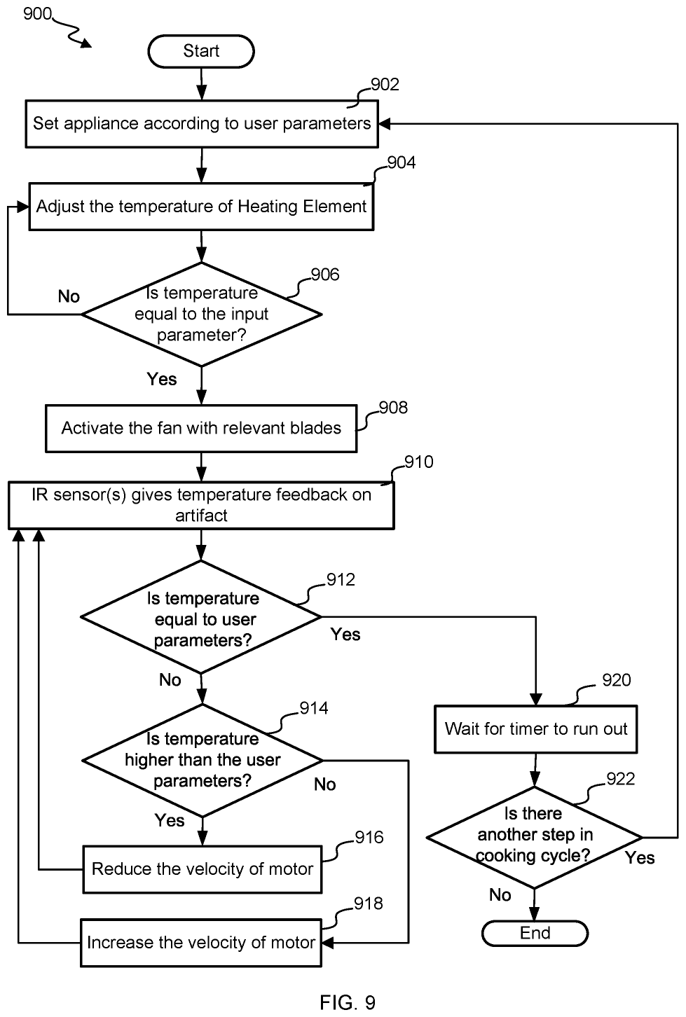

Referring to FIG. 9, a flow chart of an embodiment of the control system 112 regulating the user parameters for cooking the artifact 504 is shown. The control system 112 sets up the appliance for operation, at block 902. The settings for the cooking appliance depend upon the user parameters entered either directly from the interface 114 or the user application 118. At block 904, the control system 112 activates the heating element 108, which is usually a resistive coil, according to the desired temperature specified in the user parameters. The heating coil has a PID controller 110 connected with IR sensor temperature feedback to adjust the power to the heating coil 404 and/or fan(s) 104.

At block 906, the control system 112 checks the actual temperature after an initial boot up time to ensure the proper function of the apparatus. If the actual temperature is equal to the user parameter, the system 100 moves to the next step, if not the loop of adjusting the heating element 108 continues.

At block 908, the control system 112 activates the fan(s) 104 according to the selected function. The different geometries of blades of the fans 104 and their orientation create different patterns of airflow. The airflow pattern affects the heat transfer to the surface of the artifact 504. By changing the airflow pattern the different functions 604 are achieved. For example, the fans 104 create an even airflow on each side when the frying selection is preferred to have a golden crisp all over the artifact 504. It is to be noted that the fans 104 can be of different designs that may be preinstalled or swapped in the field in the cooking appliance. The placement and number of the fans 104 can vary in different embodiments.

At block 910, IR sensor(s) 102 provides a temperature profile of the surface of the artifact 504. The temperature profile indicates the heat absorbed by the artifact 504 in different areas. If one part has much more heat compared to other areas, the control system 112 will adjust the airflow. In another embodiment, any type of thermal camera can be utilized for this purpose. At block 912, the control system 112 checks if the temperature of the artifact 504 matches the user parameter. Where the temperature measured is as desired at block 920, the control system 112 keeps the artifact in these conditions until the predefined time has elapsed. At block 922, the control system 112 checks for the next step in the cooking cycle. If there exists another step, the control system 112 initializes the cooking appliance to the setting of that step and continues the process. If not, the cooking cycle is terminated.

If it is determined at block 912 that the temperature checked by the control system 112 is higher or lower than specified by the user parameter, processing goes to block 914. If the temperature of the artifact 504 is higher, the control system 112 reduces the velocity of the motor 302 that in turn reduces the heat transfer to the artifact 504. If the temperature of the artifact 504 is lower than the specified in the user parameters, the velocity of airflow is turned up accordingly. The temperature is again checked by the IR sensor(s) 102 again by looping back to block 910 and continues until the actual temperature matches the temperature measurement in the user parameter.

It is to be understood that although the advantages and features of the control method for an air fryer of the present invention are illustrated by way of example in the system 100, the specific configuration of the cooking appliance is exemplary only and does not constitute a limitation on the control method for an air fryer of the present invention. For example, in other examples of the present invention, the specific structure of the cooking appliance may also be implemented as other types of structures as long as the desired cooking effect can be achieved. Instead of an air fryer, the system can be implemented in an oven, microwave, countertop toaster, etc.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

We claim:

1. A cooking appliance with a variable airflow for cooking an artifact using convection current, the cooking appliance comprising:
a fan, wherein the fan creates the variable airflow;
a motor with variable speed control;
a communication module;
an interface coupled with the communication module that receives a function of cooking and a plurality of user parameters for cooking the artifact, wherein the interface receives a function of cooking and the plurality of user parameters for cooking the artifact;
a control system to affect the variable speed control; and
a temperature sensor to provide temperature measurement of the artifact without making contact between the temperature sensor and the artifact to the control system that regulates the variable airflow according to the plurality of user parameters and the temperature measurement.

2. The cooking appliance with the variable airflow for cooking the artifact using convection current in claim 1, further comprises:
a variac integrated with a motor to control and monitor a velocity of an airflow, wherein the velocity of the airflow is dependent on the function.

3. The cooking appliance with the variable airflow for cooking the artifact using convection current in claim 1, wherein the fan is configured with a removable blade based on the function and the blade of a plurality of blades with has a different geometry than an another blade.

4. The cooking appliance with the variable airflow for cooking the artifact using convection current in claim 1, further comprises:
a controller that controls a direction of rotation of the fan, wherein the direction of rotation of the fan determines the direction of the airflow.

5. The cooking appliance with the variable airflow for cooking the artifact using convection current in claim 1, a user can skip a step of a selection of the plurality of user parameters by selecting an automated option, wherein the automated option is a suggestion of the plurality of user parameters corresponding to the function.

6. The cooking appliance with the variable airflow for cooking the artifact using convection current in claim 1, a composition of the artifact is inferred from a selection of the function.

7. The cooking appliance with the variable airflow for cooking the artifact using convection current in claim 1, wherein the plurality of user parameters is programmed through a user application for a cooking cycle with different periods.

8. The cooking appliance with the variable airflow for cooking the artifact using convection current in claim 1, wherein the fan of a plurality of fans in the cooking appliance can be activated depending upon the function, wherein the plurality of fans has a plurality of geometries configured to create the variable airflow.

9. The cooking appliance with the variable airflow for cooking the artifact using convection current in claim 1, wherein the temperature sensor is an infrared (IR) sensor.

10. A method for controlling a cooking appliance with a variable airflow for cooking an artifact using convection current, the method comprising:
receiving a plurality of user parameters and a function from a user through an interface or a user application;
controlling an airflow depending upon the function by a plurality of blades with variable geometries;
sensing temperature of a surface of the artifact through a temperature sensor without making contact with the artifact; and
regulating the plurality of user parameters of the airflow to achieve the function.

11. The method for controlling the cooking appliance with the variable airflow for cooking the artifact using convection current in claim 10, further comprises:
a variac integrated with a motor to control and monitor a velocity of a fan, wherein the velocity of the airflow is dependent on the function.

12. The method for controlling the cooking appliance with the variable airflow for cooking the artifact using convection current in claim 10, wherein a fan is configured a removable blade based on the function and a blade of the plurality of blades with has a different geometry than an another blade.

13. The method for controlling the cooking appliance with the variable airflow for cooking the artifact using convection current in claim 10, further comprises:
a controller that controls a direction of rotation of a fan, wherein the direction of rotation of the fan determines the direction of the airflow.

14. The method for controlling the cooking appliance with the variable airflow for cooking the artifact using convection current in claim 10, a user can skip a step of a selection of the plurality of user parameters by selecting an automated option, wherein the automated option is a suggestion of the plurality of user parameters corresponding to the function.

15. The method for controlling the cooking appliance with the variable airflow for cooking the artifact using convection current in claim 10, a composition of the artifact is inferred from a selection of the function.

16. The method for controlling the cooking appliance with the variable airflow for cooking the artifact using convection current in claim 10, wherein the plurality of user parameters are programmed through a user application for a cooking cycle with different periods.

17. The method for controlling the cooking appliance with the variable airflow for cooking the artifact using convection current in claim 10, wherein a fan of a plurality of fans in the cooking appliance can be activated depending upon the function, wherein the plurality of fans has a plurality of geometries configured to create the variable airflow.

18. A cooking appliance with a variable airflow for cooking an artifact using convection current, the cooking appliance comprising:
a fan, wherein the fan creates the variable airflow;
a motor with variable speed control; a communication module;
a variac integrated with a motor to control and monitor a velocity of the fan, wherein the velocity of an airflow is dependent on a function;
an interface coupled with the communication module that receives a function of cooking and a plurality of user parameters for cooking the artifact, wherein the interface receives the function of cooking and the plurality of user parameters for cooking the artifact;
a control system to affect the variable speed control; and
an infrared (IR) sensor to provide temperature measurement of the artifact without making contact between the IR sensor and the artifact to the control system that regulates the variable airflow according to the plurality of user parameters and the temperature measurement.

19. The cooking appliance with the variable airflow for cooking the artifact using convection current in claim 18, wherein the fan is configured with a removable blade based on the function and a blade of a plurality of blades with has a different geometry than an another blade.

20. The cooking appliance with the variable airflow for cooking the artifact using convection current in claim 18, further comprises:
a controller that controls a direction of rotation of the fan, wherein the direction of rotation of the fan determines the direction of the airflow.

21. The cooking appliance with the variable airflow for cooking the artifact using convection current in claim 18, a user can skip a step of a selection of the plurality of user parameters by selecting an automated option, wherein the automated option is a suggestion of the plurality of user parameters corresponding to the function.

22. The cooking appliance with the variable airflow for cooking the artifact using convection current in claim 18, a composition of artifact is inferred from a selection of the function.

23. The cooking appliance with the variable airflow for cooking the artifact using convection current in claim 18 wherein the plurality of user parameters is programmed through a user application for a cooking cycle with different periods.

24. The cooking appliance with the variable airflow for cooking the artifact using convection current in claim 18, wherein the fan of a plurality of fans in the cooking appliance can be activated depending upon the function, wherein the plurality of fans has a plurality of geometries configured to create the variable airflow.
